(19) United States
(12) Patent Application Publication
(10) Pub. No.: US 2005/0051032 A1
(43) Pub. Date: Mar. 10, 2005

(54) Heating control apparatus and method for controlling household bean milk and bean curd makers

(76) Inventor: Hong-bae Kim, Koyang-city (KR)

Correspondence Address: SHLESINGER, ARKWRIGHT & GARVEY LLP, 1420 KING STREET, SUITE 600, ALEXANDRIA, VA, 22314, US

(21) Appl. No.: 10/902,271

(22) Filed: Jul. 30, 2004

(30) Foreign Application Priority Data
Aug. 6, 2003 (KR) 2003-25354

(51) Int. Cl. A23L 1/00

(52) U.S. Cl. 99/280; 99/281; 99/325; 99/331

(57) ABSTRACT

Heating control apparatus and method for controlling household bean milk and bean curd makers, which set a primary heating temperature to be relatively low, thus preventing beans from being excessively finely ground during a grinding process while reducing power consumption, in use. The control apparatus and method set a secondary heating temperature to be relatively high to heat the beans for a short period of time, in use, in a household bean milk and bean curd maker, thus sufficiently boiling the ground beans while reducing power consumption. A temperature sensor senses a temperature and a key input device allows a user to input commands. A control increases a primary heating temperature sufficiently to prevent beans from being excessively finely ground, and maintains a secondary heating temperature sufficiently long after the beans are ground, to cause the beans to be sufficiently boiled, while reducing power consumption.

### CROSS-REFERENCE TO RELATED APPLICATIONS

This application claims the priority of Korean application no. 2003-25354, filed Aug. 6, 2003, which is incorporated herein by reference.

This application relates to U.S. application Ser. No. 10/897,421, filed Jul. 23, 2004, entitled “Overheat Prevention Device for Household Bean Milk and Bean Curd Maker” and this application relates to U.S. application Ser. No. 10/131,460, filed Apr. 25, 2002, now U.S. Pat. No. 6,653,941, issued Nov. 25, 2003, and this application relates to U.S. application Ser. No. 10/131,192, filed Apr. 25, 2002, now U.S. Pat. No. 6,703,723, issued Mar. 9, 2004.

### FIELD OF THE INVENTION

The present invention relates generally to household bean milk and bean curd makers and, more particularly, to a heating control apparatus and method for household bean milk and bean curd makers, which sets a primary heating temperature to be relatively low, thus preventing beans from being excessively finely ground during a grinding process while reducing power consumption, and which sets a secondary heating temperature to be relatively high to heat the beans for a short period of time, thus sufficiently boiling the ground beans while reducing power consumption.

### BACKGROUND OF THE INVENTION

The process of making bean milk and bean curd using a traditional method is as follows.

First, beans are washed, and the washed beans are soaked in water for many hours. The soaked beans are ground by a mill or a blender to obtain an extract of beans. The extract of beans is strained through a sieve or closely perforated cloth to be divided into bean curd dregs and an extract of protein.

Next, only the extract of protein is put into a vessel, such as a pot, and boiled. At this time, froth is inevitably generated and overflows out of the vessel. Thus, in order to prevent the froth from overflowing out of the vessel, heating power must be carefully regulated by a user. After the extract of protein is boiled for a predetermined period, additives, including sugar and salt, are added to the extract of protein. Thus, the bean milk is finished.

Meanwhile, when the user desires to make watery bean curd or bean curd, a coagulant, such as calcium sulphate, is stirred into the boiled extract of protein. After several minutes, the watery bean curd is made. Further, when the watery bean curd is pressed in a frame to have a predetermined shape, the bean curd is made.

However, the conventional method of making bean milk and bean curd has a problem in that several processes are individually executed, thus it is inconvenient and complicated to make the bean milk and the bean curd, and it takes longer time to make the bean milk and the bean curd, thereby the conventional method is inefficient.

In order to solve the problems, there have been proposed various devices for easily and conveniently making bean milk and bean curd at home. For example, there are Korean Patent No. 99-225772, Korean Patent No. 2000-228659, Korean U.M. Registration No. 158856, Korean U.M. Registration No. 250843, etc, that are disclosed by the applicant of the present invention. The Korean Patent No. 99-225772 was published on Oct. 15, 1999, and is titled “Household Bean Curd Maker”. The Korean Patent No. 2000-228659 was published on Mar. 15, 2000, and is titled “Household Bean Curd Maker”. The Korean U.M. Registration No. 158856 was registered on Jul. 16, 1999, and is titled “Household Bean Curd Maker”. The Korean U.M. Registration No. 250843 was registered on Oct. 5, 2001, and is titled “Household Bean Curd Maker with Fixed-type Blade Unit”.

A conventional household bean milk and bean curd maker will be described in the following with reference to FIG. 1.

FIG. 1 is a sectional view of the conventional household bean milk and bean curd maker. As shown in FIG. 1, the conventional household bean milk and bean curd maker includes a housing 11 which has a cavity to contain water therein. A main body 12 is provided on an upper portion of the housing 11 to open or close the housing 11, like a lid. A drive motor 13 is installed in a predetermined portion of the main body 12, and generates rotating power when electricity is applied to the drive motor 13. A drive shaft 14 transmits the rotating power from the drive motor 13. A cutting blade 15 is provided at an end of the drive shaft 14. A heater 16 downwardly extends from the main body 12, and generates heat when electricity is applied to the heater 16, thus heating an interior of the housing 11. A temperature sensing bar 17 detects the temperature of the interior of the housing 11. A filter net 18 is detachably mounted to a predetermined portion of the main body 12, and contains beans therein.

The conventional household bean milk and bean curd maker constructed as described above is operated as follows.

First, a user puts the beans into the filter net 18. The filter net 18 containing the beans is assembled with the main body 12, and then water is put into the housing 11. Thereafter, the main body 12 is placed on the upper portion of the housing 11 so that the filter net 18 is put into the housing 11.

Next, when a power switch (not shown) is turned on to apply electricity to the household bean milk and bean curd maker, a control unit (not shown) outputs a control signal to operate the heater 16 and the temperature sensing bar 17. At this time, a primary heating process is executed while maintaining a predetermined temperature. Thereafter, as the drive motor 13 is operated, the beans contained in the filter net 18 are ground by the cutting blade 15 provided at the end of the drive shaft 14.

As such, while the beans are ground, the turbulence of water contained in the housing 11 is caused by rotation of the cutting blade 15. By the turbulence, bean grains which are finely ground by the cutting blade 15 come out of the filter net 18. Thus, the beans ground by the cutting blade 15 are divided into bean-curd dregs which remain in the filter net 18, and the extract of protein which flows out of the filter net 18.

Thereafter, the control unit (not shown) outputs a control signal to operate the heater 16 and the temperature sensing bar 17. At this time, a secondary heating process is executed while maintaining a predetermined temperature. Through the above-mentioned process, bean milk is obtained.

When the user desires to make bean curd, the user takes the heated extract of protein out of the housing 11. Next, the coagulant is added to the heated extract of protein so as to coagulate the extract of protein. Thereafter, the coagulated protein is pressed in the frame to produce the bean curd.

However, the conventional household bean milk and bean curd maker is problematic in that a heater still operates even when froth is generated and overflows out of the main body during the making of bean milk, thus spoiling contents contained in the main body and possibly damaging the maker.

In order to solve the conventional problem, technology capable of eliminating generated froth and preventing damage to a maker by stopping the operation of a heater when the froth is generated in a main body has been proposed in Korean U.M. Registration No. 272969 that is entitled “Froth Detecting and Eliminating Apparatus for Household Bean Milk, Watery Bean Curd and Bean Curd Makers”, published on Apr. 20, 2002, and filed by the present applicant.

However, such a conventional household bean milk and bean curd maker is problematic in that, since a froth sensor is additionally installed, the manufacturing cost of the maker is increased.

In order to solve the problem, technology, not requiring a froth sensor, that controls temperature to prevent the generation of froth, has been proposed in Korean Pat. Publication No. 2003-60845 that is entitled “Method of Making Bean Curd/Bean Milk by Bean Curd Maker” and published on Jul. 16, 2003.

However, the technology disclosed in the “Method of Making Bean Curd/Bean Milk by Bean Curd Maker” is problematic in that, since a primary heating temperature is set to a relatively high temperature of about 93 to 94° C., power consumption is increased, and beans are excessively finely ground during the grinding process to cause bean curd to be excessively tender, and since a secondary heating temperature is set to a relatively low temperature of 93 to 94° C., ground beans are not sufficiently boiled.

### OBJECTS AND SUMMARY OF THE INVENTION

It is an object of the invention to overcome the problems and the drawbacks of the prior art.

It is another object of the invention to reduce and eliminate undesirable frothing, underheating and overheating of the beans, the bean curd milk, and like constituents, during all phases of the preparation process for bean milk and bean curd making, as well as overgrinding and undergrinding of the beans which may result in the beans not being sufficiently ground or being ground too finely.

Accordingly, the present invention has been made keeping in mind the above problems occurring in the prior art, and an object of the present invention is to provide a heating control apparatus and method for household bean milk and bean curd makers, which sets a primary heating temperature to be relatively low, thus preventing beans from being excessively finely ground during a grinding process while reducing power consumption, and which sets a secondary heating temperature to be relatively high to heat the beans for a short period of time, thus sufficiently boiling the ground beans while reducing power consumption.

The invention includes a bean milk and bean curd maker, as well as a heating control and method of controlling bean milk and bean curd makers that control the bean milk and bean curd making process in the desired fashion. The heating control apparatus and method, and the maker incorporating such, control the heating, duration of heating, cycling, and the like for achieving the above.

In order to accomplish the above object, the present invention further provides a heating control apparatus for household bean milk and bean curd makers, comprising a temperature sensor for sensing a temperature, converting the temperature into an electrical signal, and outputting the electrical signal, key input means for allowing a user to input operation commands, control means for increasing a primary heating temperature until the primary heating temperature reaches 78° C., thus preventing beans from being excessively finely ground while reducing power consumption, and for maintaining a secondary heating temperature at 95 to 100° C. for 30 seconds after the beans are ground, thus allowing the ground beans to be sufficiently boiled while reducing power consumption, motor driving means for driving a motor by supplying power to the motor in response to a control signal provided from the control means, and heater driving means for driving a heater by supplying power to the heater in response to a control signal provided from the control means.

Further, the present invention provides a heating control method for household bean milk and bean curd makers, comprising outputting a control signal to a heater driving unit to drive a heater when an operation starts and a user inputs an operation command, thus performing primary heating, determining whether a heating temperature has exceeded 78° C. during the primary heating, stopping the heater when the heating temperature has exceeded 78° C., grinding the beans by operating a motor after the primary heating has been completed, driving the heater after grinding of beans has been completed, thus performing secondary heating, performing heating for a short period of about 30 seconds while maintaining a heating temperature at 95 to 100° C. during the secondary heating, and stopping the heating after the secondary heating has been sufficiently performed.

Likewise, the present invention includes a bean milk and bean curd maker, such as a household bean milk and bean curd maker, which incorporates the heating control method and control apparatus that controls the operation, duration, and cycling of the heating of the beans and liquid provided in the bean milk and bean curd maker, for achieving the desired product.

### BRIEF DESCRIPTION OF THE DRAWINGS

FIG. 1 is a sectional view of a conventional household bean milk and bean curd maker;

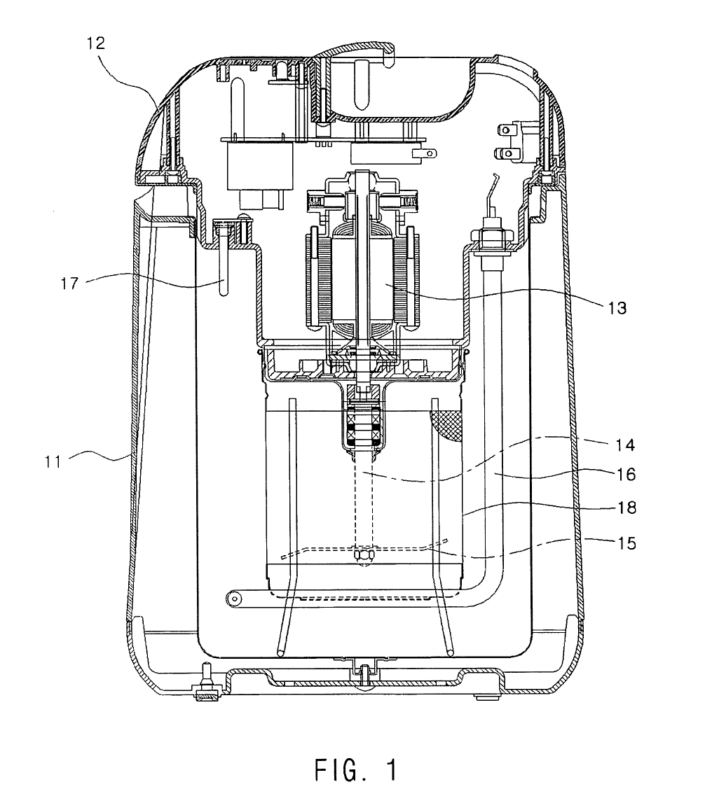

FIG. 2 is a view showing the construction of a heating control apparatus for household bean milk and bean curd makers according to an embodiment of the present invention;

FIG. 3 is a flowchart showing the operation of a heating control method for household bean milk and bean curd makers according to an embodiment of the present invention; and

FIG. 4 is a sectional view of a household bean milk and bean curd maker including a heating control apparatus for controlling the heating of the household bean milk and bean curd maker, in use, according to the invention.

It will be appreciated that relative terms, such as left, right, up, and down, are for convenience only and are not intended to be limiting.

### DETAILED DESCRIPTION OF THE INVENTION

Hereinafter, an embodiment of the present invention will be described in detail with reference to the attached drawings. The above and other objects, features and other advantages of the present invention will be more clearly understood from the following detailed description taken in conjunction with the accompanying drawings.

Although the preferred embodiment of the present invention has been disclosed for illustrative purposes, those skilled in the art will appreciate that various modifications, additions and substitutions are possible, without departing from the scope and spirit of the invention as disclosed in the accompanying claim.

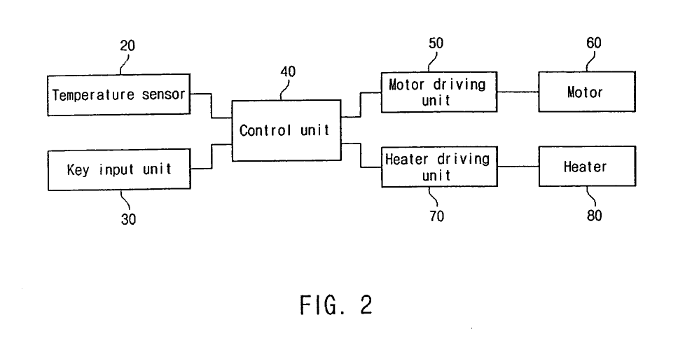

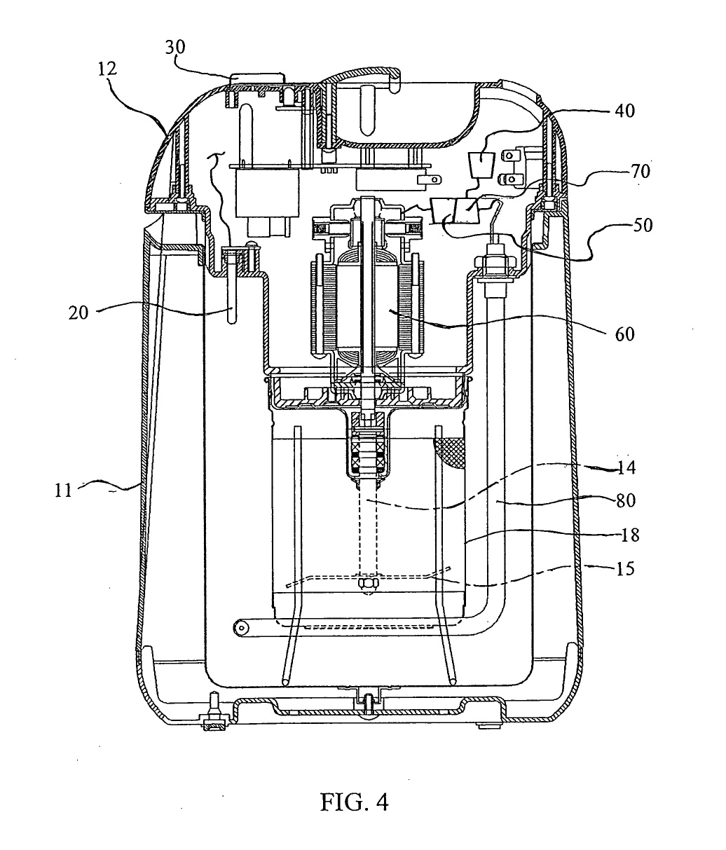

As shown in FIGS. 2-4, a heating control apparatus for household bean milk and bean curd makers according to an embodiment of the present invention includes a temperature sensor 20 that senses a temperature, converts the temperature into an electrical signal, and outputs the electrical signal, a key input unit 30 that allows a user to input operation commands, a control unit 40 that increases a primary heating temperature until the primary heating temperature reaches 78° C., thus preventing beans from being excessively finely ground while reducing power consumption, and maintains a secondary heating temperature at 95 to 100° C. for 30 seconds after the beans are ground, thus allowing the ground beans to be sufficiently boiled while reducing power consumption, a motor driving unit 50 that drives a motor 60 by supplying power to the motor 60 in response to a control signal provided from the control unit 40, and a heater driving unit 70 that drives a heater 80 by supplying power to the heater 80 in response to a control signal provided from the control unit 40.

The heating control method for household bean milk and bean curd makers according to an embodiment of the present invention includes the steps of starting to operate when power is supplied (S10), reading a signal input from the key input unit and determining whether the user has input an operation command (S20), outputting a control signal to the heater driving unit to drive the heater when the user has input the operation command, thus performing primary heating (S30), reading a signal input from the temperature sensor during the primary heating and determining whether a heating temperature has exceeded 78° C. (S40), stopping the heater when the heating temperature has exceeded 78° C. (S50), grinding beans by operating the motor after the primary heating has been completed (S60), operating the heater after the grinding of beans has been completed, thus performing secondary heating (S70), heating the beans for a short period of about 30 seconds while maintaining a heating temperature at 95 to 100° C. during the secondary heating (S80), stopping the heating after the secondary heating has been sufficiently performed (S90), and stopping the above process (S100).

The operations of the heating control apparatus and method for household bean milk and bean curd makers according to the embodiments of the present invention, having the above constructions, are described below.

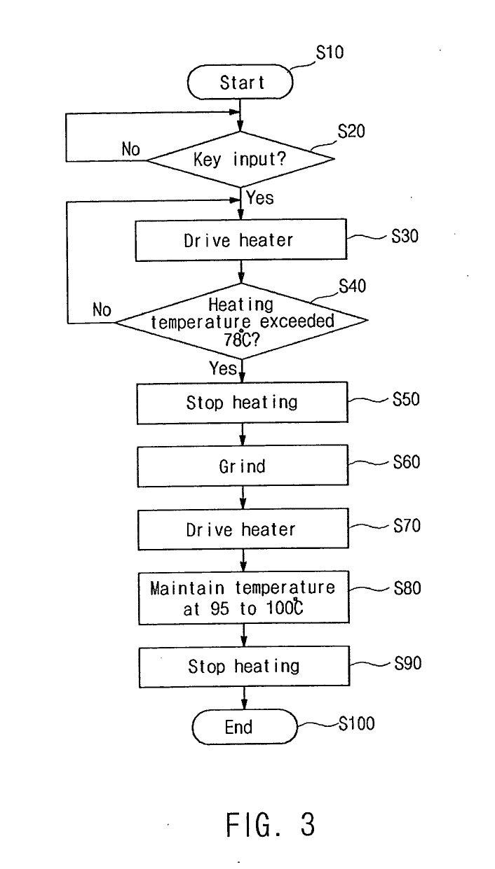

When power is supplied, and the operating process of FIG. 3 stored in an internal memory of the control unit 40 in the form of a program is executed by the control unit 40, the operation of the heating control apparatus starts at step S10.

When the operation starts, the control unit 40 reads a signal input from the key input unit 30 and then determines whether the user has input an operation command at step S20.

When the user has input the operation command, the control unit 40 outputs a control signal to the heater driving unit 70 to drive the heater 80, thus performing primary heating at step S30.

During the performance of the primary heating as described above, the control unit 40 reads a signal input from the temperature sensor 20 and then determines whether a heating temperature has exceeded 78° C. at step S40. When the heating temperature has exceeded 78° C., the control unit 40 outputs a control signal to the heater driving unit 70 to stop the heater 80 at step S50.

In the above primary heating, the primary heating temperature is set to be a relatively low temperature equal to or lower than 78° C., which is a sufficient temperature to eliminate the fish-like smell of the beans while setting the grinding rate of beans to 70% or lower in a subsequent grinding process, thus forcibly steeping the beans. Therefore, the beans are prevented from being excessively finely ground in the subsequent grinding process while power consumption is minimized.

After the primary heating has been completed, the control unit 40 outputs a control signal to the motor driving unit 50 to drive the motor 60, thus executing the grinding process by a cutting blade connected to the shaft of the motor 60 at step S60.

After the grinding process has been completed, the control unit 40 outputs a control signal to the heater driving unit 70 to drive the heater 80, thus performing secondary heating at step S70.

During the secondary heating process, the control unit 40 reads a signal input from the temperature sensor 20 to suitably control the operation of the heater, thus performing heating for a short period of about 30 seconds while maintaining a secondary heating temperature at 95 to 100° C. at step S80. The secondary heating temperature is set to be a relatively high temperature of 95 to 100° C., which is a sufficient temperature to cause the ground beans to be sufficiently boiled, so that the heating is briefly performed for about 30 seconds, thus enabling the ground beans to be sufficiently boiled while reducing power consumption.

After the secondary heating has been completed, the control unit 40 stops the heating at step S90, and terminates the above entire process after repeatedly performing a series of operations as described above several times at step S100.

As described above, the present invention provides a heating control apparatus and method for household bean milk and bean curd makers, which sets a primary heating temperature to be relatively low, thus preventing beans from being excessively finely ground during a grinding process while reducing power consumption, and which sets a secondary heating temperature to be relatively high to heat the beans for a short period of time, thus sufficiently boiling ground beans while reducing power consumption.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A heating control apparatus for household bean milk and bean curd makers, comprising:
a) a temperature sensor provided for sensing a temperature in a household bean milk and bean curd maker, converting the temperature into an electrical signal, and outputting the electrical signal;
b) key input means provided for allowing a user to input operation commands in a household bean milk and bean curd maker;
c) control means provided for increasing a primary heating temperature in a household bean milk and bean curd maker until the primary heating temperature reaches 78° C., thus preventing beans from being excessively finely ground while reducing power consumption, and for maintaining a secondary heating temperature at 95 to 100° C. for 30 seconds after the beans are ground, thus allowing the ground beans to be sufficiently boiled while reducing power consumption, in use;
d) motor driving means provided for driving a motor in a household bean milk and bean curd maker by supplying power to the motor in response to a control signal provided from the control means; and
e) heater driving means provided for driving a heater in a household bean milk and bean curd maker by supplying power to the heater in response to a control signal provided from the control means.

2. A heating control method for household bean milk and bean curd makers, comprising:
a) outputting a control signal to a heater driving unit in a household bean milk and bean curd maker to drive a heater when an operation starts and a user inputs an operation command, thus performing primary heating;
b) determining whether a heating temperature in a household bean milk and bean curd maker has exceeded 78° C. during the primary heating;
c) stopping the heater in a household bean milk and bean curd maker when the heating temperature has exceeded 78° C.;
d) grinding the beans in a household bean milk and bean curd maker by operating a motor after the primary heating has been completed;
e) driving the heater in a household bean milk and bean curd maker after grinding of beans has been completed, thus performing secondary heating;
f) performing heating in a household bean milk and bean curd maker for a short period of about 30 seconds while maintaining a heating temperature at 95 to 100° C. during the secondary heating; and
g) stopping the heating in a household bean milk and bean curd maker after the secondary heating has been sufficiently performed.

3. A household bean milk and bean curd maker, heating control apparatus comprising:
a) a housing;
b) a heater provided in the housing;
c) a motor provided in the housing;
d) a blade provided in the housing, the blade being driven by the motor sufficiently fast to grind beans, in use;
e) a heating control apparatus, including:
i) a temperature sensor provided for sensing a temperature in the household bean milk and bean curd maker, converting the temperature into an electrical signal, and outputting the electrical signal, in use;
ii) a key input device provided for allowing a user to input operation commands in the household bean milk and bean curd maker, in use;
iii) a control provided for increasing a primary heating temperature in the household bean milk and bean curd maker until the primary heating temperature reaches about 78° C., thus preventing beans from being excessively finely ground while reducing power consumption, and for maintaining a secondary heating temperature at about the boiling point of water for a sufficiently long period of time after the beans are ground, so that the ground beans are sufficiently boiled while reducing power consumption, in use;
iv) a motor driving element provided for driving the motor in the household bean milk and bean curd maker by supplying power to the motor in response to a control signal provided from the control, in use; and
v) a heater driving element provided for driving a heater in the household bean milk and bean curd maker by supplying power to the heater in response to a control signal provided from the control.

4. A household bean milk and bean curd maker as in claim 3, wherein:
a) a filter net is provided in the housing; and
b) the blade is provided inside the filter net.

5. A household beam milk and bean curd maker as in claim 3, wherein:
a) the secondary heating temperature is 95-100° C.

6. A household bean milk and bean curd maker as in claim 5, wherein:
a) the secondary heating temperature is maintained for about 30 seconds.

7. A household bean milk and bean curd maker as in claim 3, wherein:
a) the secondary heating temperature is maintained for about 30 seconds.
